(19) United States
(12) Patent Application Publication
(10) Pub. No.: US 2026/0067072 A1
(43) Pub. Date: Mar. 5, 2026

(54) MOBILE CRYPTOGRAPHIC AUTHENTICATION METHOD USING QUANTUM RANDOM NUMBERS

(71) Applicant: BASESTONE Co., Ltd., Sejong-si (KR)

(72) Inventor: Yoo Shin PARK, Namyangju-si (KR)

(73) Assignee: BASESTONE Co., Ltd., Sejong-si (KR)

(21) Appl. No.: 19/379,601

(22) Filed: Nov. 4, 2025

Related U.S. Application Data
(63) Continuation of application No. PCT/KR2024/095126, filed on Feb. 14, 2024.

(30) Foreign Application Priority Data
May 8, 2023 (KR) 10-2023-0059015

(51) Int. Cl. H04L 9/08; H04L 9/32

(52) U.S. Cl. CPC H04L 9/0852; H04L 9/0869; H04L 9/3226

(57) ABSTRACT

The present invention relates to a mobile cryptographic authentication method using quantum random numbers, and more particularly, to a mobile cryptographic authentication method using quantum random numbers including: a mobile unit including a security program installed on a user's mobile device; a server unit of an administrator that receives access data from the mobile unit of an unspecified plurality of users; and a quantum generation unit that is separated from the server unit and generates security codes comprised of quantum random numbers, wherein the server unit receives a user ID, a password, and quantum random numbers input by a user from the mobile unit and authorizes access to the server unit.

### CROSS-REFERENCE TO RELATED APPLICATION

This application is a Continuation of PCT International Patent Application No. PCT/KR2024/095126 filed on Feb. 14, 2024, under 35 U.S.C. § 371, which claims the benefit of Korean Patent Application No. 10-2023-0059015 filed on May 8, 2023, the entire contents of which are incorporated herein by reference.

### BACKGROUND

### (a) Technical Field

The present invention relates to a mobile cryptographic authentication method using quantum random numbers, and more particularly, to a mobile cryptographic authentication method using quantum random numbers comprising: a mobile unit including a security program installed on a user's mobile device; a server unit of an administrator that receives access data from mobile units of an unspecified plurality of users; and a quantum generation unit that is separated from the server unit and generates security codes comprised of quantum random numbers, wherein the server unit receives a user ID, a password, and quantum random numbers input by a user from the mobile unit and authorizes access to the server unit.

### (b) Background Art

Contents described in this section merely provide background information on the present invention and do not constitute the related art.

A legacy mobile cryptographic authentication method, an OTP method, has random number generators installed respectively in a user and an authentication server that generate the same value at the same time.

This random number generator is set such that a random number of an administrator's authentication server and a random number of a user's device have the same value every one minute cycle.

For example, if the random number of the authentication server is 1251861, the random number generated on the user's device at the same time is also 1251861.

When the user attempts to log in to the authentication server, the user enters an ID and password and directly inputs a value of a generated OTP, which is then transmitted to the authentication server.

The authentication server determines whether to grant or deny access after verifying that values of an ID, a password, and an OTP received from the user match data stored in the authentication server.

However, each time the user attempts to log in, the user must additionally input an OTP value having an unfamiliar value, in addition to entering the familiar ID and password.

This can be considered excellent for comparing third data in addition to ID and password from a security perspective, but causes inconvenience from a user convenience standpoint because users must enter new and unfamiliar values each time.

Furthermore, a method such as OTP has a problem of limited number of digits because users must enter the values directly.

Meanwhile, the OTP method has a problem that the OTP must be entered urgently within a valid time period, as the OTP method generates and deletes random numbers at predetermined intervals.

To solve the aforementioned problems of conventional mobile OTP methods, some domestic and overseas related companies have conducted research on mobile cryptographic authentication methods with improved security and convenience, but the costs for actual commercialization are excessive, or even when not excessive, the security effectiveness of such cryptographic methods is not outstanding, resulting in reduced market competitiveness compared to conventional OTP methods, and no cases of full-scale commercialization could be found.

Therefore, development of a device capable of solving the problems of the conventional technology as described above is required.

### SUMMARY OF THE DISCLOSURE

The problem to be solved by the present invention is to make up for the shortcomings of the prior art mentioned above, and objects of the present invention are as follows.

First, an object of the present invention is to provide a mobile cryptographic authentication method using quantum random numbers, wherein the user simply enters an ID and a password in the same manner as a legacy access method, making an access method familiar and simple, but the access determination is made based not only on the ID and password but also on a third factor other than the ID and password through quantum random numbers.

Second, an object of the present invention is to provide a mobile cryptographic authentication method using quantum random numbers, wherein a user's mobile unit, an administrator's server unit, and a separately configured third entity, quantum generation unit are organically interconnected, thereby safely and rapidly performing a series of access security procedures comprising the mobile unit, server unit, and quantum generation unit based on valid quantum random numbers without time limitations.

The objects of the present invention are not limited to the aforementioned objects, and other objects, which are not mentioned above, will be apparently understood by a person having ordinary skill in the art from the following description.

According to the present invention, provided is a mobile cryptographic authentication method using quantum random numbers comprising: a mobile unit including a security program installed on a user's mobile device; a server unit of an administrator that receives access data from mobile units of an unspecified plurality of users; and a quantum generation unit that is separated from the server unit and generates security codes comprised of quantum random numbers, wherein the server unit receives a user ID, a password, and quantum random numbers input by a user from the mobile unit and authorizes access to the server unit.

In this case, when the mobile unit requests access to the server unit, the server unit converts the request into a signal and transmits the signal to the quantum generation unit, and the quantum generation unit may generate a security code comprising quantum random numbers and then transmit the security code to each of the mobile unit and the server unit.

Furthermore, a security program installed in the mobile unit may transmit the user ID and password directly entered by the user to the server unit, and may transmit the quantum random number received from the quantum generation unit to the server unit without requiring user input.

In this case, the quantum random number may include a number having 100 or more digits.

Furthermore, the server unit may permit access by the mobile unit when the ID, password, and quantum random number received from the mobile unit all match the ID, password, and quantum random number stored in the server unit, and immediately delete data related to the quantum random number immediately after access.

Meanwhile, the server unit may disapprove access by the mobile unit when the ID, password, and quantum random number received from the mobile unit match even any one of the ID, password, and quantum random number stored in the server unit, and immediately delete data related to the quantum random number.

Furthermore, the quantum generation unit may include a basic quantum random number generation unit that generates N arbitrary basic quantum random numbers like number₁, number₂ to numberₙ through a planar detection method or a binarization method using ground glass, a twin quantum random number generation unit that generates N arbitrary twin quantum random numbers like twin₁, twin₂ to twinₙ, and a quantum random number processing unit that combines the quantum random numbers twin₁, twin₂ to twinₙ formed by the twin quantum random number generation unit with at least one of the basic quantum random numbers number₁ or numberₙ formed by the basic quantum random number generation unit.

In this case, an N number of the twinₙ is less than or equal to half of the N number of the numberₙ, and the quantum random number processing unit may generate quantum random numbers by simultaneously combining the twin quantum random numbers twin₁, twin₂ to twinₙ formed by the twin quantum random number generation unit with the number₁ and the numberₙ.

Further, the quantum generation unit may include an artificial random number generation unit that generates an arbitrary N number of artificial random numbers, such as intentional₁, intentional₂, to intentionalₙ placed between each of the intentional quantum random numbers generated from the twin quantum random number generation unit.

Furthermore, the artificial random number generation unit is configured such that when values of consecutive twin quantum random numbers are identical (e.g., twin₁=twin₂), the artificial random number has a value different from the two twin quantum random numbers (e.g., intentional₁≠twin₁ and twin₂), and when values of consecutive twin quantum random numbers are different (e.g., twin₁≠twin₂), the artificial random number may have a value of either one of the two twin quantum random numbers.

Additional solutions of the present invention will be partially described in the description that follows below, and may be partially easily identified from the description, or may be learned by practicing the present invention.

Both the foregoing general description and the following detailed description are only exemplary and explanatory, and do not limit the present invention as set forth in the claims.

Effects of the present invention configured as above are described as below.

First, the user simply enters an ID and a password in the same manner as a legacy access method, making an access method familiar and simple, but the access determination may be made based not only on the ID and password but also on a third factor other than the ID and password.

Second, a user's mobile unit, an administrator's server unit, and a separately configured third entity, quantum generation unit are organically interconnected, thereby safely and rapidly performing a series of access security procedures comprising the mobile unit, server unit, and quantum generation unit based on valid quantum random numbers without time limitations.

The effects of the present invention are not limited to the aforementioned effect, and other effects, which are not mentioned above, will be apparently understood by a person having ordinary skill in the art from the description of the claims.

### BRIEF DESCRIPTION OF THE DRAWINGS

FIG. 1 is a conceptual diagram of a conventional OTP security method.

FIG. 2 is a conceptual diagram of a mobile cryptographic authentication method using quantum random numbers according to an embodiment of the present invention.

FIG. 3 is a flowchart of a mobile cryptographic authentication method using quantum random numbers according to an embodiment of the present invention.

### DETAILED DESCRIPTION

Hereinafter, specific exemplary embodiments of the present invention will be described in detail with reference to the accompanying drawings.

Further, in describing a specific exemplary embodiment of the present invention, detailed description of associated known function or constitutions will be omitted if it is determined that they unnecessarily make the gist of the present invention unclear.

The aforementioned objects, features, and advantages of the present invention will be clearer through the following detailed description associated with the accompanying drawings. However, the present invention may have various modifications and include various embodiments, so hereinafter, specific embodiments will be illustrated in the drawings and described in detail.

When it is determined that the detailed description of associated known function or constitutions unnecessarily may obscure the gist of the present invention, it will be omitted. Additionally, numbers used in the description process of this specification are merely identification symbols to distinguish one component from another component.

Further, suffix “unit” for components used in the following description is used or mixed up only to facilitate the preparation of the specification, and does not have distinct meanings roles in itself.

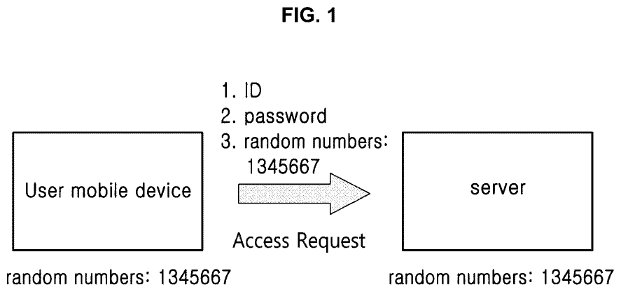

FIG. 1 is a conceptual diagram of a conventional OTP security method.

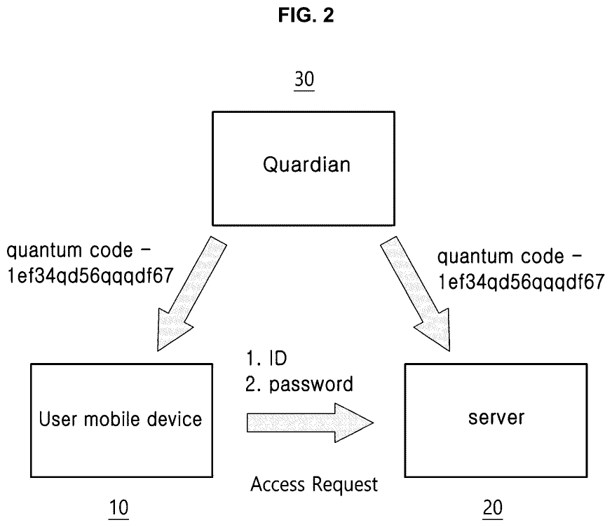

FIG. 2 is a conceptual diagram of a mobile cryptographic authentication method using quantum random numbers according to an embodiment of the present invention.

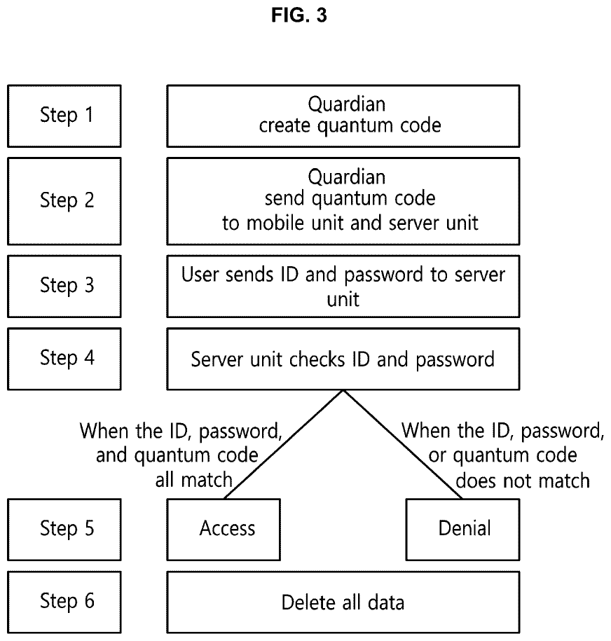

FIG. 3 is a flowchart of a mobile cryptographic authentication method using quantum random numbers according to an embodiment of the present invention.

According to the present invention, provided is a mobile cryptographic authentication method using quantum random numbers comprising: a mobile unit including a security program installed on a user's mobile device; a server unit of an administrator that receives access data from mobile units of an unspecified plurality of users; and a quantum generation unit that is separated from the server unit and generates security codes comprised of quantum random numbers, wherein the server unit receives a user ID, a password, and quantum random numbers input by a user from the mobile unit and authorizes access to the server unit.

Meanwhile, although an environment accessed by the user is described herein as a mobile unit such as a portable device like a smartphone, it is obvious that the present invention is not limited thereto and may also be applied to non-mobile computer environments such as personal PCs, public PCs, and the like.

In this case, when the mobile unit requests access to the server unit, the server unit converts the request into a signal and transmits the signal to the quantum generation unit, and the quantum generation unit may generate a security code comprising quantum random numbers and then transmit the security code to each of the mobile unit and the server unit.

Furthermore, a security program installed in the mobile unit may transmit the user ID and password directly entered by the user to the server unit, and may transmit the quantum random number received from the quantum generation unit to the server unit without requiring user input.

By adding a third factor in addition to the user ID and password in the access method, it is possible to comparatively determine whether information values match, thereby improving security while simultaneously improving user convenience since the information entered by the user is limited to the user ID and password set by the user.

This may be regarded as a highly innovative mobile password authentication method that may resolve user inconvenience while improving security.

That is, the user simply enters an ID and a password in the same manner as a legacy access method, making an access method familiar and simple, but an administrator may determine whether information provided by the mobile unit and information stored in the server unit match based not only on the ID and password but also on a third factor other than the ID and password, and authorize the user access according to whether both information matches.

The conventional OTP method is cumbersome because the user has to directly enter an OTP that is changed every time, unlike the ID and password, and there was a problem that the number of digits of the OTP is limited because the user has to directly enter the OTP.

However, in the mobile cryptographic authentication method using quantum random numbers according to an embodiment of the present invention, the user does not need to directly input a third value (here, the quantum random number) that is changed each time, and since the program matches the third value without direct user input, there is no limitation on the number of digits, allowing for very long or complex formats (for example, while the conventional OTP method consists of 6 to 10 digits as illustrated in FIG. 1, the mobile cryptographic authentication method using quantum random numbers according to an embodiment of the present invention may combine numbers and letters as illustrated in FIG. 2, such as 1ef34qd56qqqdf67, and may have very long digit counts), thereby improving security.

Furthermore, in the mobile cryptographic authentication method using quantum random numbers according to an embodiment of the present invention, the quantum random number may be composed only of numbers, only of English letters, only of special characters, or may be combined to include at least two or more of numbers, English letters, and special characters, and may have a length of 1 to 100,000 digits, and when the quantum generation unit generates quantum random numbers, a pattern may be changed each time.

More specifically, the format of the quantum random number may be changed each time. For example, during generation one time, the quantum random number may be a 3-digit number consisting only of numbers; during generation two times, the quantum random number may be a 10-digit combination of numbers and letters; during generation three times, the quantum random number may be a 50-digit combination of numbers and English letters; during generation four times, the quantum random number may be a 3-digit combination of numbers and English letters; during generation five times, the quantum random number may be a 100-digit number consisting only of English letters; during generation six times, the quantum random number may be a 5-digit combination of numbers, English letters, and special characters, and so on, having a new pattern each time.

This is a method that is not feasible for convenience with an OTP where the user must directly input the code, and may be regarded as one of the most significant features of the present invention.

OTP patterns may be measured based on data accumulated over an extended period (pattern identification is possible because the OTP employs a pseudo-random number (PRN) method). Consequently, data access by third parties is possible, whereas a QRN method makes pattern identification impossible because no pattern exists.

The server unit permits access by the mobile unit when the ID, password, and quantum random number received from the mobile unit all match the ID, password, and quantum random number stored in the server unit, and may immediately delete data related to the quantum random number immediately after access.

Meanwhile, the server unit disapproves access by the mobile unit when the ID, password, and quantum random number received from the mobile unit do not match even any one of the ID, password, and quantum random number stored in the server unit, and may immediately delete data related to the quantum random number.

Meanwhile, the quantum generation unit according to an embodiment of the present invention may adopt a quantum generation method previously filed by the present applicant.

For example, a quantum random encryption key generation method disclosed in Korean Patent No. 10-2486888, which is registered to the same patentee as the present applicant, may be employed.

Accordingly, the quantum generation unit may include a basic quantum random number generation unit that generates N arbitrary basic quantum random numbers like number₁, number₂ to numberₙ through a planar detection method or a binarization method using ground glass, a twin quantum random number generation unit that generates N arbitrary twin quantum random numbers like twin₁, twin₂ to twinₙ, and a quantum random number processing unit that combines the quantum random numbers twin₁, twin₂, to twinₙ formed by the twin quantum random number generation unit with at least one of the basic quantum random numbers number₁ or numberₙ formed by the basic quantum random number generation unit.

In this case, an N number of the twinₙ is less than or equal to half of the N number of the numberₙ, and the quantum random number processing unit may generate quantum random numbers by simultaneously combining the twin quantum random numbers to twin₁, twin₂ to twinₙ formed by the twin quantum random number generation unit with the number₁ and the numberₙ.

Further, the quantum generation unit may include an artificial random number generation unit that generates an arbitrary N number of artificial random numbers, such as intentional₁, intentional₂ to intentionalₙ to placed between each of the twin quantum random numbers generated from the twin quantum random number generation unit.

Furthermore, the artificial random number generation unit is configured such that when values of consecutive twin quantum random numbers are identical (e.g., twin₁=twin₂), the artificial random number has a value different from the two twin quantum random numbers (e.g., intentional₁≠twin₁ and twin₂), and when values of consecutive twin quantum random numbers are different (e.g., twin₁≠twin₂), the artificial random number may have a value of either one of the two twin quantum random numbers.

This embodiment is merely illustrative of the technical spirit of the present invention and various changes and modifications of this embodiment can be made by those skilled in the art to which the present invention pertains without departing from an essential characteristic of the present invention.

This embodiment is not intended to limit the technical spirit of the present invention, but rather to illustrate it, and therefore, the scope of the present invention is not limited to this embodiment.

The protection scope of the present invention should be construed based on the claims and it should be appreciated that all technical spirits recognized as being equal or equivalent to the claims belong to the scope of the present invention.

What is claimed is:

1. A mobile cryptographic authentication method using quantum random numbers, comprising:
a mobile unit including a security program installed on a user's mobile device;
a server unit of an administrator that receives access data from mobile units of an unspecified plurality of users; and
a quantum generation unit that is separated from the server unit and generates security codes comprised of quantum random numbers,
wherein the server unit receives a user ID, a password, and quantum random numbers input by a user from the mobile unit and authorizes access to the server unit.

2. The mobile cryptographic authentication method using quantum random numbers of claim 1, wherein when the mobile unit requests access to the server unit, the server unit converts the request into a signal and transmits the signal to the quantum generation unit, and the quantum generation unit generates a security code comprised of quantum random numbers and then transmits the security code to each of the mobile unit and the server unit.

3. The mobile cryptographic authentication method using quantum random numbers of claim 2, wherein a security program installed in the mobile unit transmits the user ID and password directly entered by the user to the server unit, and transmits the quantum random number received from the quantum generation unit to the server unit without requiring user input.

4. The mobile cryptographic authentication method using quantum random numbers of claim 3, wherein the server unit
permits access by the mobile unit when the ID, password, and quantum random number received from the mobile unit all match the ID, password, and quantum random number stored in the server unit, and immediately deletes data related to the quantum random number immediately after access, and
disapproves access by the mobile unit when the ID, password, and quantum random number received from the mobile unit do not match even any one of the ID, password, and quantum random number stored in the server unit, and immediately deletes data related to the quantum random number.

5. The mobile cryptographic authentication method using quantum random numbers of claim 4, wherein the quantum random number includes a number having 100 or more digits.

6. The mobile cryptographic authentication method using quantum random numbers of claim 4, wherein the quantum random number may be composed only of numbers, only of English letters, only of special characters, or may be combined to include at least two or more of numbers, English letters, and special characters, and may have a length of 1 to 100,000 digits, and when the quantum generation unit generates quantum random numbers, a pattern is changed each time.

7. The mobile cryptographic authentication method using quantum random numbers of claim 3, wherein the quantum generation unit includes:
a basic quantum random number generation unit that generates N arbitrary basic quantum random numbers like number₁, number₂ to numberₙ through a planar detection method or a binarization method using ground glass;
a twin quantum random number generation unit that generates N arbitrary twin quantum random numbers like twin₁, twin₂ to twinₙ; and
a quantum random number processing unit that combines the quantum random numbers twin₁, twin₂ to twinₙ formed by the twin quantum random number generation unit with at least one of the basic quantum random numbers number₁ or numberₙ formed by the basic quantum random number generation unit,
wherein an N number of the twinₙ is less than or equal to half of the N number of the numberₙ, and
the quantum random number processing unit generates quantum random numbers by simultaneously combining twin quantum random numbers twin₁, twin₂ to twinₙ formed by the twin quantum random number generation unit with the and the numberₙ.

8. The mobile cryptographic authentication method using quantum random numbers of claim 7, wherein the quantum generation unit includes an artificial random number generation unit that generates arbitrary N number of artificial random numbers, such as intentional₁, intentional₂ to intentionalₙ placed between each of the twin quantum random numbers generated from the twin quantum random number generation unit, and
the artificial random number generation unit is configured such that when values of consecutive twin quantum random numbers are identical (e.g., twin₁=twin₂), the artificial random number has a value different from the two twin quantum random numbers (e.g., intentional₁≠twin₁ and twin₂), and when values of consecutive twin quantum random numbers are different (e.g., twin₁≠twin₂), the artificial random number has a value of either one of the two twin quantum random numbers.
